(19) United States
(12) Patent Application Publication
(10) Pub. No.: US 2017/0024438 A1
(43) Pub. Date: Jan. 26, 2017

(54) METHOD AND SYSTEM FOR DATA INTEGRATION

(71) Applicant: Hannda Co., Ltd., Seoul (KR)

(72) Inventor: SUN KWON KIM, Seoul (KR)

(21) Appl. No.: 14/971,330

(22) Filed: Dec. 16, 2015

(30) Foreign Application Priority Data
Jul. 21, 2015 (KR) 10-2015-0103228

(51) Int. Cl. G06F 17/30

(52) U.S. Cl. CPC G06F 17/30483; G06F 17/30533

(57) ABSTRACT

Provided is a data integration method and system. The data integration method includes: accessing, by a computer, first data and second data; extracting information that is an integration target from the first data and generating a first table; extracting information that is an integration target from the second data and generating a second table; generating at least one change set by performing comparison between the first table and the second table using at least one Structured Query Language (SQL) query including a set operation; and applying the generated at least one change set to the second data.

### BACKGROUND OF THE INVENTION

The present invention disclosed herein relates to data integration, and more particularly, to a data integration method and a data integration system using the data integration method, which integrates a source data system storing original data and a target data system storing duplicate data at high speed.

Customer data integration is a process of integrating and managing various sources of customer data inside and outside an enterprise, databases, and customer information received from the respective business departments of the enterprise, and is a key component or an important issue of a Customer Relationship Management (CRM) system.

The customer information frequently changes or disappears, or newly occurs. In order to increase the customer satisfaction degree while saving the operating cost of the CRM system and the marketing cost and establish the foundation of increase in sales by developing new customers, it is necessary to quickly and accurately integrate information that is being physically or logically divided and managed in various places.

Data integration means deleting a lost record, adding a new record, and updating a record having different contents while having the same key value. A process of updating only a changed part of existing customer information occupies most of time that is taken for data integration.

Informatica or Scribe that is a typical CRM data integration system runs a loop to update changed data, but this method has a limitation in that too much time is taken to integrate hundreds of thousands of records or millions of records.

Recently, a big data system having a form of a distributed file system instead of an existing relational database is being increasingly used. The big data system manages data in a structured or non-structured form by connecting several computer systems in a data cluster.

In such a big data system, an efficient data integration method that can integrate customer data scattered around a plurality of computers is needed.

### SUMMARY OF THE INVENTION

The present invention provides a data integration method and system, which can quickly integrate data that are being managed in a plurality of data systems.

The present invention also provides a data integration method and system, which can quickly integrate data that data systems having different structures are managing.

The present invention also provides a data integration method and system, which can quickly perform integration of massive data that are managed in a form other than a relational database like a big data system.

Embodiments of the present invention provide methods including: accessing, by a computer, first data and second data; extracting information that is an integration target from the first data and generating a first table; extracting information that is an integration target from the second data and generating a second table; generating at least one change set by performing comparison between the first table and the second table using at least one Structured Query Language (SQL) query including a set operation; and applying the generated at least one change set to the second data.

In some embodiments, the generating of the at least one change set may include generating at least one of an addition change set, a deletion change set, and an update change set from data of the first table and the second table by executing at least one SQL including a set operation.

In other embodiments, the generating of the at least one change set may include: generating a first change set to be added to the second data by subtracting the data of the second table from the data of the first table; generating a second change set to be deleted from the second data by subtracting the data of the first table from the data of the second table; and generating a third change set to be modified in the second data by extracting a record in which key values of the first table and the second table are equal but values of other fields are not equal.

In still other embodiments, the data integration method may further include generating the at least one SQL query for generating the at least one change set with reference to a mapping structure of the first table and the second table.

In other embodiments of the present invention, data integration systems include: a communication unit for accessing first data and/or second data; a relational database; and a controller for integrating the first data and the second data using the relational database, wherein the controller extracts information that is a target of integration from the first data and the second data to generate a first table and a second table, respectively, generates at least one change set by performing comparison between the first table and the second table using at least one Structure Query Language (SQL) query including a set operation, and applies the generated at least one change set to the second data.

In some embodiments, controller may generate at least one of an addition change set, a deletion change set, and an update change set from data of the first table and the second table by executing at least one SQL including a set operation.

In other embodiments, the controller may generate a first change set to be added to the second data by subtracting data of the second table from data of the first table, may generate a second change set to be deleted from the second data by subtracting the data of the first table from the data of the second table, and may generate a third change set to be modified in the second data by extracting a record in which key values of the first table and the second table are equal but values of other fields are not equal.

In still other embodiments, the controller may automatically generate the at least one SQL query for generating the at least one change set with reference to a mapping structure of the first table and the second table.

In even other embodiments, the data integration system may be implemented inside a source data system storing the first data or a target data system storing the second data, or may be implemented in a separate system.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating a configuration of a data integration system according to an embodiment of the present invention;

FIG. 2 is a flowchart illustrating a data integration method according to an embodiment of the present invention;

FIG. 3 is a view illustrating examples of original data and duplicate data used in a data integration method according to an embodiment of the present invention;

FIG. 4 is a view illustrating a method of mapping source data and target data according to an embodiment of the present invention;

FIG. 5 is a view illustrating an example of a change set generating query automatically generated with reference to a mapping structure according to an embodiment of the present invention; and

FIG. 6 is a view illustrating an example of a change set according to an embodiment of the present invention.

### DETAILED DESCRIPTION OF PREFERRED EMBODIMENTS

Hereinafter, terms used herein will be described in brief, and then the present invention will be described in detail.

Terms used in this disclosure are selected as general terms that are being widely used in the present time as possible, but these terms may be changed according to the intention of persons skilled in the arts, precedents, and emergence of new technologies. Also, there are terms arbitrarily selected by the present applicant in a specific case, and in this case, the meanings of them will be described in detail in the explanation part of the corresponding invention. Accordingly, terms used in this disclosure should be defined based on the meaning of the terms and the contents throughout the present invention instead of the simple appellation of the terms.

Furthermore, when it is described that one comprises (or includes or has) some elements, it should be understood that it may comprise (or include or has) only those elements, or it may comprise (or include or have) other elements as well as those elements if there is no specific limitation. Also, the terms such as “ . . . unit”, “ . . . part”, and “module” described in this disclosure denote a unit of processing at least one function or operation, and these may be implemented in hardware or software or may be implemented in a combination of hardware and software.

Hereinafter, exemplary embodiments of the present invention will be described in detail with reference to the accompanying drawings so that those skilled in the art can easily carry out the present invention. However, the present invention can be implemented in various types, and is not limited to the embodiments set forth herein. Also, parts irrelevant to the description of the present invention will be omitted for clarification of description, and like parts are indicated as like reference numerals throughout the specification.

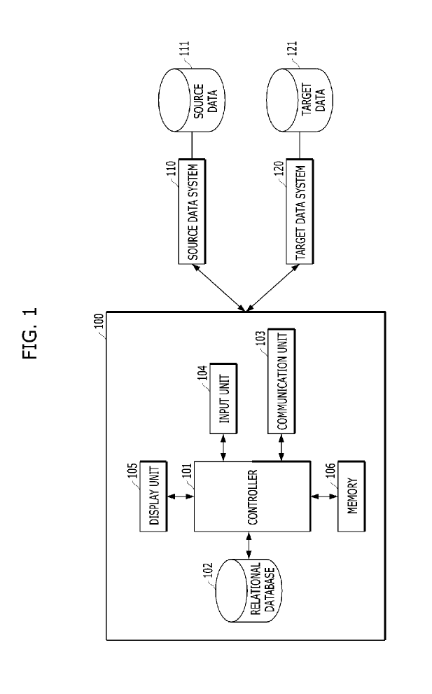

FIG. 1 is a view illustrating a configuration of a data integration system according to an embodiment of the present invention.

A data integration system 100 according to an embodiment of the present invention may be a computing apparatus that comprises a communication unit 103, a relational database system 102, and a controller 101. The communication unit 103 may communicate with a source data system 110 and/or a target data system 120 to access source data 111 stored in the source data system 110 and/or target data 121 stored in the target data system 120. The relational database system 102 may be used to generate a work table and a change set for data integration. The controller 101 may perform a series of processes for integrating the source data 111 and the target data 121 using the relational database system 102.

Also, the data integration system 101 may include an input unit 104 for receiving data and/or commands from a user (data integration manager), a display unit 105 for displaying a current state and each processing and operating state according to the input of a user and displaying various kinds of output data generated in the data integration system 100, and a memory 106 storing programs and data for controlling the operation of the data integration system 100.

The source data 111 may be an original data, and the target data 121 may be a duplicate data. The target data 121 may be changed into the latest data included in the source data 111 during the data integration process.

The controller 101 may extract information that is a target of integration from the source data 111 and the target data 121 to generate a first table and a second table, respectively, may generate at least one change set by comparing the first table and the second table using at least one Structure Query Language (SQL) query including a set operation, and may apply the generated at least one change set to the target data 121.

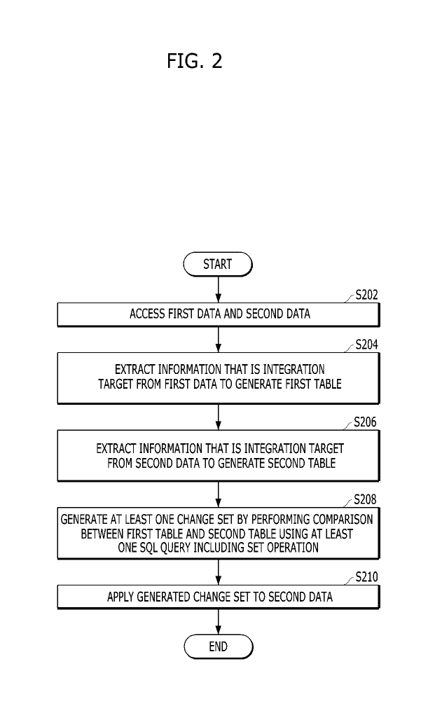

Thus, the data integration system 100 may perform data integration by generating the comparison target tables (first table and second table) in the relational database system 102. However, the source data 111 of the source data system 110 and the target data 121 of the target data system 120 may not be limited to table data of the relational database, and may be another type of data such as big data. The operation and role of the controller 101 will be described in detail with reference to FIGS. 2 to 6 later.

On the other hand, FIG. 1 shows that the data integration system 100 is implemented into a separate system from the source data system 110 and the target data system 120, but the data integration software and/or the relational database used for the data integration may be implemented so as to operate inside the source data system 110 and the target data system 120 in accordance with embodiments. In this case, since data communication with the source data system 110 and the target data system 120, particularly, copy of information that is a target of mapping is performed from just one side system, the data integration processing may become faster.

Also, FIG. 1 shows that the relational database 102 provided in the data integration system 100 is used, but data integration may also be processed by generating comparison target tables in a relational database that the source data system 110 or the target data system 120 includes.

For the communication between the data integration system 100 and the source data system 110 or the target data system 120, wired or wireless communication method may be used. In this case, a wired network such as Local Area Network (LAN) and Wide Area Network (WAN) or a wireless network such as mobile communication network, satellite communication network, Wireless Fidelity (WiFi), and Bluetooth may be used, but the present invention is not limited to any one form of communication networks.

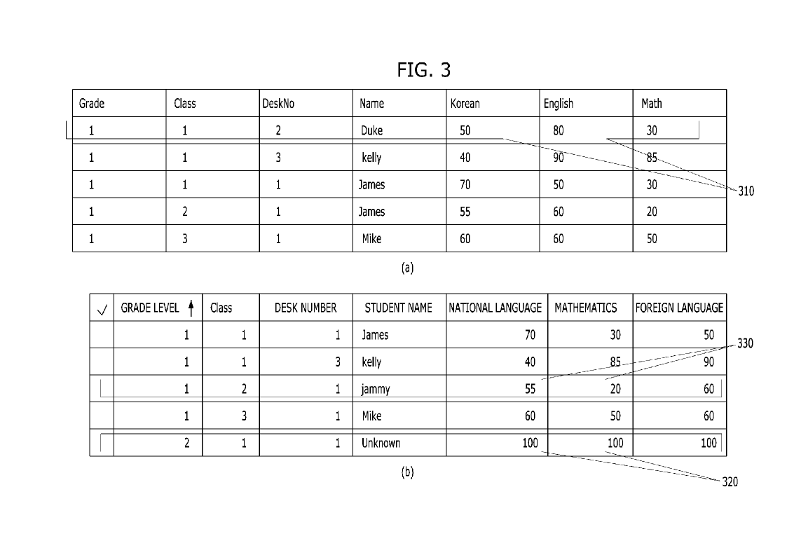

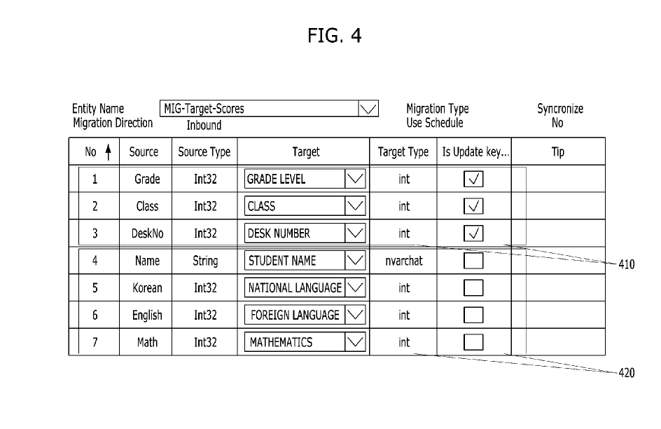

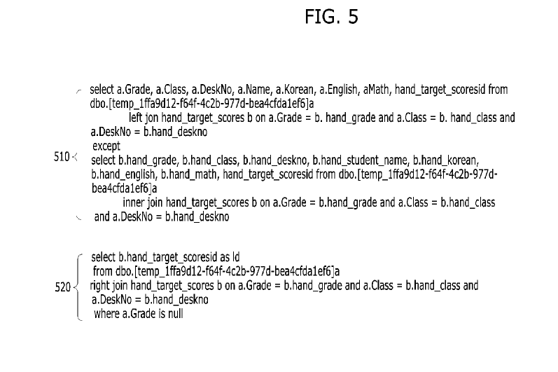

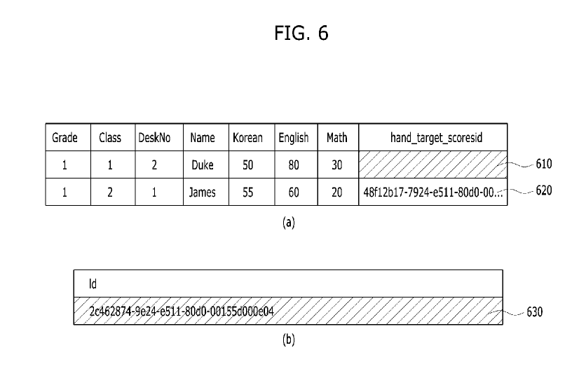

FIG. 2 is a flowchart illustrating a data integration method according to an embodiment of the present invention. FIG. 3 is a view illustrating examples of original data and duplicate data used in a data integration method according to an embodiment of the present invention. FIG. 4 is a view illustrating a method of mapping source data and target data according to an embodiment of the present invention. FIG. 5 is a view illustrating an example of a change set generating query automatically generated with reference to a mapping structure according to an embodiment of the present invention. FIG. 6 is a view illustrating an example of a change set according to an embodiment of the present invention.

Referring to FIG. 2, the first data and the second data that are targets of integration may be first accessed (S202). The first data may be the source data 111 that the source data system 110 has, and the second data may be the target data 121 that the target data system 120 has. The respective data 111 and 121 may be accessed by connecting the systems 110 and 120 in accordance with a connection or communication method between the data integration system 100 and the source data system 110 or the target data system 120.

Next, information that is an integration target may be extracted from the first data to generate the first table in the relational database 102 (S204), and information that is an integration target may be extracted from the second data to generate the second table in the relational database 102 (S206). In this case, all information or fields that the first data and the second data have may not be extracted, and only information or fields that are predetermined for mapping may be copied and converted into tabular data. When the first data and the second data are originally tabular data, a predetermined field may be brought and used without a conversion.

(a) of FIG. 3 shows an example of the first table (original table) generated by extracting the mapping target information from the source data, and (b) of FIG. 3 shows an example of the second table (duplicate table) generated by extracting the mapping target information from the target data. As shown in FIG. 3, when the field name of the source data and the field name of the target data are different from each other, a process of mapping the source data and the target data may be needed as shown in FIG. 4.

Also, even when the field names are equal to each other, mapping may be needed. However, when the field names are equal to each other, it may be possible to automate mapping.

Referring to FIG. 4, ‘Grade’ of the source data and ‘grade level’ of the target data, ‘Class’ of the source data and ‘class’ of the target data, ‘Deskno’ of the source data and ‘desk number’ of the target data, ‘Name’ of the source data and ‘student name’ of the target data, ‘Korean’ of the source data and ‘national language’ of the target data, ‘English’ of the source data and ‘foreign language’ of the target data, and ‘Math’ of the source data and ‘mathematics’ of the target data may be data that are mutually mapped. Also, it can be seen that Grade (grade level)-Class (class)-Deskno (desk number) are key values of each record. That is, Grade (glade level), Class (class), Deskno (desk number) may be a key field 410, and Name (student name), Korean (national language), English (foreign language), and Math (mathematics) may be a data field 420.

Referring again to FIG. 3, since a record having a key value 1-1-2 exists in the source data but does not exist in the target data, the record may be a record 310 to be added to the target data, a record having a key value 2-1-1 exists in the target data but does not exist in the source data, the record may be a record 320 to be deleted from the target data. Also, since a record having a key value 1-2-1 is changed in content thereof, the record may be a record 330 to be modified.

In order to determine the record 310 to be added, the record 320 to be deleted, and the record 330 to be modified as shown in FIG. 3, a process of comparing whether or not the first table and the second table are equal to each other may be performed.

In the above-mentioned process, the comparison between the first table and the second table may be performed using at least one Structured Query Language (SQL) query including a set operation, and thus at least one change set may be generated (S208).

The change set may include three change sets, and each change set may include a record to be added to the target data, a record to be deleted from the target data, or a record to be updated in the target data.

In this embodiment, at least one SQL including a difference set operation may be executed to generate the change set, and at least one of an addition change set, a deletion change set, and an update change set may be generated from data of the first table and the second table.

Specifically, the addition change set to be added to the second data may be generated by subtracting the data of the second table from the data of the first table, and the deletion change set to be deleted from the second data may be generated by subtracting the data of the first table from the data of the second table. In addition, the update change set to be modified in the second data may be generated by extracting a record in which the key values of the first table and the second table are equal but values of other fields are not equal. In order to generate the addition change set and the deletion change set, the difference set operation may be performed using only key field(s). Also, in order to generate the update change set, record(s) remaining as a result by matching key values and then performing the difference set operation may be assigned to the update change set.

In one embodiment, an SQL query for generating the change set may be automatically generated with reference to the mapping structure of the first table and the second table.

FIG. 5 shows an example of SQL queries that are automatically generated. A first query 510 may be a query that can generate an addition change set in which the second table (target) is subtracted from the first table (source) and a deletion change set in which the first table (source) is subtracted from the second table (target), including the difference set operation. A second query 520 may be a query that can generate an update change set by extracting a record in which the key field values match with each other but the data fields are different from each other, including the set operation.

As a result of executing SQL queries including the set operation as shown in FIG. 5, change sets may be outputted as tabular data as shown in FIG. 6.

Referring to (a) of FIG. 6, an addition change set 610 including a record having a key value 1-1-2 and an update change set 620 including a record having a key value 1-2-1 may be generated. Also, referring to (b) of FIG. 6, a deletion change set 630 including identification information of a record that needs to be deleted because existing only on the target table may be generated.

In this embodiment, at least one of the addition change set, the deletion change set, and the update change set may be generated in accordance with contents of the first data (source data) and the second data (target data) may be generated, and when the generated at least one change set is applied to the second data, the data integration may be completed (S210).

Specifically, record(s) including in the addition change set may be added to the second data, and record(s) included in the deletion change set may be deleted from the second data. Also, in regard to record(s) included in the update change set, records of the second data corresponding to key values of each record may be modified into data values of the data field of the update change set.

Such data synchronization may be performed according to data transaction call methods (query, API: Application Programming Interface, and RPC: Remote Procedure Call) that are supported in the target data system 120.

On the other hand, in the operation S208, the direction of data integration may be set by a user. The above-mentioned embodiment has been described as implemented in inbound mode in which the source data (original data) update the target data (duplicate data). However, in outbound mode, the duplicate data may update the original data.

In Informatica or Scribe that is a related-art, since a method of fetching about 5,000 records and comparing all of them in the process of comparing whether or not the first table and the second table are equal to each other by an agent is used, the processing time may be long.

On the other hand, in the data integration method according to the embodiment of the present invention, since the relational database system is used in operation S208 regardless of the type of the source data and the target data, time may be taken only for movement of data, and little time may be taken for operation S208. Accordingly, data integration can be processed faster about 20 times to about 150 times than the related-art.

According to an embodiment of the present invention, since changed data sets are determined in advance and then synchronization performed only on a small quantity of change set, time and cost spent for integration of data that are being managed in a plurality of data system can be saved.

Also, it is possible to quickly integrate data that data systems having different structures are managing.

Furthermore, it is possible to quickly perform integration of massive data that are managed in a form other than a relational database like a big data system.

In addition, since data that need to be updated are outputted in a table form of a relational database, the utilization of data can be high, and relevant web services can be provided using the outputted table data.

A method according to an embodiment of the present invention can also be embodied into a form of program instruction executable through various computer means, and can be recorded on computer readable media. The computer readable media may include program instructions, data files, data structures, or combinations thereof. The program instructions recorded in the media may be what is specially designed and constructed for the present invention, or may be what is well-known to computer software engineers skilled in the art. Examples of computer readable recording media include hard disk, magnetic media such as floppy disks and magnetic tapes, optical media such as CD-ROM and DVD, magneto-optical media such as floptical disk, and hardware devices such as ROM, RAM, and flash memory, which are specially configured so as to store and perform program instructions. Examples of program instructions may include high-level language codes which can be executed by computers using an interpreter and the like, as well as machine language codes which are made by a compiler.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A data integration method comprising:
accessing, by a computer, first data and second data;
extracting information that is an integration target from the first data and generating a first table;
extracting information that is an integration target from the second data and generating a second table;
generating at least one change set by performing comparison between the first table and the second table using at least one Structured Query Language (SQL) query including a set operation; and
applying the generated at least one change set to the second data.

2. The data integration method of claim 1, wherein the generating of the at least one change set comprises generating at least one of an addition change set, a deletion change set, and an update change set from data of the first table and the second table by executing at least one SQL including a set operation.

3. The data integration method of claim 1, wherein the generating of the at least one change set comprises:
generating a first change set to be added to the second data by subtracting the data of the second table from the data of the first table;
generating a second change set to be deleted from the second data by subtracting the data of the first table from the data of the second table; and
generating a third change set to be modified in the second data by extracting a record in which key values of the first table and the second table are equal but values of other fields are not equal.

4. The data integration method of claim 1, further comprising generating the at least one SQL query for generating the at least one change set with reference to a mapping structure of the first table and the second table.

5. A data integration system comprising:
a communication unit for accessing first data and/or second data;
a relational database; and
a controller for integrating the first data and the second data using the relational database,
wherein the controller extracts information that is a target of integration from the first data and the second data to generate a first table and a second table, respectively, generates at least one change set by performing comparison between the first table and the second table using at least one Structure Query Language (SQL) query including a set operation, and applies the generated at least one change set to the second data.

6. The data integration system of claim 5, wherein the controller generates at least one of an addition change set, a deletion change set, and an update change set from data of the first table and the second table by executing at least one SQL including a set operation.

7. The data integration system of claim 5, wherein the controller generates a first change set to be added to the second data by subtracting data of the second table from data of the first table, generates a second change set to be deleted from the second data by subtracting the data of the first table from the data of the second table, and generates a third change set to be modified in the second data by extracting a record in which key values of the first table and the second table are equal but values of other fields are not equal.

8. The data integration system of claim 5, wherein the controller automatically generates the at least one SQL query for generating the at least one change set with reference to a mapping structure of the first table and the second table.

9. The data integration system of claim 5, implemented inside a source data system storing the first data or a target data system storing the second data, or implemented in a separate system.
